(19) United States
(12) Patent Application Publication
(10) Pub. No.: US 2024/0051468 A1
(43) Pub. Date: Feb. 15, 2024

(54) HOOK FOR AUTOMOBILE

(71) Applicant: YANAN ZENG, Shenzhen (CN)

(72) Inventor: YANAN ZENG, Shenzhen (CN)

(21) Appl. No.: 18/493,333

(22) Filed: Oct. 24, 2023

Related U.S. Application Data
(63) Continuation-in-part of application No. 17/527,019, filed on Nov. 15, 2021.

(51) Int. Cl. B60R 7/08

(52) U.S. Cl. CPC B60R 7/08

(57) ABSTRACT

The present disclosure provides a hook for an automobile. The hook for an automobile includes a connection main body, a first hanging portion and a second hanging portion. The first hanging portion and the second hanging portion are arranged at two ends of the connection main body and parallel to the connection main body, so as to facilitate a user to hang a storage bag for storing garbage on the first hanging portion or the second hanging portion. Moreover, due to a small space occupied by the hook, the hook will not block forward and backward movements of front seats and will not affect the comfort of the passenger. It is not only facilitates the user to replace the storage bag, but also has no garbage residue.

### CROSS-REFERENCE TO RELATED APPLICATIONS

This application is a Continuation-in-Part of the U.S. application Ser. No. 17/527,019 filed on Nov. 15, 2021, and entitled “TRAY FOR CAR”, now pending, the entire disclosures of which are incorporated herein by reference.

### TECHNICAL FIELD

The present disclosure relates to the technical field of automobiles, and in particular, to a hook for an automobile.

### BACKGROUND

With the continuous improvement of the living standard, vehicles such as automobiles have become a necessity for customers' life. During driving, a beverage bottle of a driver, tissue, and other garbage need to be stored. At present, there are two main methods below for storage:
1. A storage bag is pasted on a central console, and disadvantages of this method are as follows: The storage bag is loose and easy to fall off, causing garbage to fall off. Furthermore, the storage bag has a too small opening, which is inconvenient to use, so that the capacity is limited.
2. A cloth or plastic garbage can is placed in an automobile, and a storage bag is sleeved in the garbage can. The disadvantage is that it is troublesome to replace the storage bag, and the garbage can is easily stained and needs to be cleaned in a timely manner. Moreover, the garbage can occupies a large space in the automobile. The garbage can also occupies a valuable space inside the automobile if the storage bag does not need to be used to store garbage.

Therefore, there is an urgent need for a hook for an automobile, which occupies a small space, would not block forward and backward movements of front seats, and would not affect the comfort of a passenger, so as to improve the user experience.

### SUMMARY

In order to overcome the shortcomings of the prior art, the present disclosure provides a hook for an automobile, including:
a connection main body, wherein the connection main body has a first end and a second end opposite the first end, and the connection main body is configured to be connected to the automobile;
a first hanging portion, wherein the first hanging portion is connected to the first end of the connection main body, and the first hanging portion is configured to hang a storage bag; and
a second hanging portion, wherein the second hanging portion is connected to the second end of the connection main body, and the second hanging portion is configured to hang a storage bag.

As the improvement of the present disclosure, the connection main body is configured to be connected to a central console of the automobile.

As the improvement of the present disclosure, a protruding direction of a first hook part of the first hanging portion is opposite to a protruding direction of a second hook part of the second hanging portion, and both the protruding directions are along an extending direction of the connection main body.

As the improvement of the present disclosure, the connection main body includes a supporting main body, a first container, and a second container; the first container is connected to two ends of the supporting main body; the supporting main body is detachably connected to a central console of the automobile; the first container is detachably connected to one end of the supporting main body; and the second container is detachably connected to the other end of the supporting main body.

As the improvement of the present disclosure, the first hanging portion has a first hanging space and a first hanging opening; the first hanging space is formed by surrounding a side wall of the first hanging portion; the first hanging opening is communicated to the first hanging space, so that a hanging lug of a storage bag is hung in the first hanging space through the first hanging opening; the first hanging portion also has several first stop parts; and the first stop parts are configured to stop the hanging lug of the storage bag in the first hanging space.

As the improvement of the present disclosure, the second hanging portion has a second hanging space and a second hanging opening; the second hanging space is formed by surrounding a side wall of the second hanging portion; the second hanging opening is communicated to the second hanging space, so that the hanging lug of the storage bag is hung in the second hanging space through the second hanging opening; the second hanging portion also has several second stop parts; and the second stop parts are configured to stop the hanging lug of the storage bag in the second hanging space.

As the improvement of the present disclosure, the first hanging portion includes a first connection part and a first hook part, and the first connection part is connected to the first end of the connection main body; a bottom of the first hook part is connected to a bottom of the first connection part; the first hanging space is formed between the first hook part and the first connection part; and the first hanging opening is formed between a top of the first connection part and a top of the first hook part.

As the improvement of the present disclosure, the second hanging portion includes a second connection part and a second hook part, and the second connection part is connected to the second end of the connection main body; a bottom of the second hook part is connected to a bottom of the second connection part; the second hanging space is formed between the second hook part and the second connection part; and the second hanging opening is formed between a top of the second connection part and a top of the second hook part.

As the improvement of the present disclosure, the first connection part is arranged in an acute angle or a right angle or an obtuse angle with the connection main body, and the second connection part is arranged in an acute angle or a right angle or an obtuse angle with the connection main body.

As the improvement of the present disclosure, the first hook part is provided with a first weight reduction groove; the first weight reduction groove is internally provided with a first reinforcing rib; the second hook part is provided with a second weight reduction groove; and the second weight reduction groove is internally provided with a second reinforcing rib.

As the improvement of the present disclosure, the first connection part has a first connection side and a second connection side; the first connection side is connected to the first end; the second connection side is connected to the first hook part; a height of the second connection side is greater than a height of the first connection side; the second connection part has a third connection side and a fourth connection side; the third connection side is connected to the second end; the fourth connection side is connected to the second hook part; and a height of the fourth connection side is greater than a height of the third connection side.

As the improvement of the present disclosure, a top of the second connection side is on a same horizontal line as a top of the first connection side; a bottom of the second connection side is located below a bottom of the first connection side; a first avoidance gap is formed between the bottom of the second connection side and the bottom of the first connection side; a top of the fourth connection side is on a same horizontal line as a top of the third connection side; a bottom of the fourth connection side is located below a bottom of the third connection side; and a second avoidance gap is formed between the bottom of the fourth connection side and the bottom of the third connection side.

As the improvement of the present disclosure, the first hanging portion is integrally formed with the connection main body, and the second hanging portion is integrally formed with the connection main body.

As the improvement of the present disclosure, the first connection part is integrally formed with the first hook part, and the second connection part is integrally formed with the second hook part.

As the improvement of the present disclosure, both the first connection part and the second connection part have a first upper side part, a first middle part, and a first lower side part; both the first hook part and the second hook part have a second upper side part, a second middle part, and a second lower side part; a first spacing is reserved between the first upper side part and the second upper side part; a second spacing is reserved between the first middle part and the second middle part; a third spacing is reserved between the first lower side part and the second lower side part; and the first spacing and the third spacing are both greater than the second spacing.

As the improvement of the present disclosure, the second upper side part is provided with a first guide slope.

As the improvement of the present disclosure, the connection main body has an inner surface and an outer surface; the first hanging portion and the second hanging portion are connected to the outer surface of the connection main body; and the inner surface is configured to be connected to a side surface of the central console of the automobile.

As the improvement of the present disclosure, the inner surface is configured to be detachably connected to the side surface of the central console of the automobile.

As the improvement of the present disclosure, the inner surface is detachably connected to the side surface of the central console of the automobile in an adhesive manner.

As the improvement of the present disclosure, the first stop parts are convexly arranged in the first hanging space; the second stop parts are convexly arranged in the second hanging space.

As the improvement of the present disclosure, a quantity of the several first stop parts is at least two; and a quantity of the several second stop parts is at least two.

As the improvement of the present disclosure, the first hanging portion includes a first connection part and a first hook part; the first connection part is connected to the first end of the connection main body; a bottom of the first hook part is connected to a bottom of the first connection part; a first hanging space is formed between the first hook part and the first connection part; the first hanging opening is formed between a top of the first connection part and a top of the first hook part; the second hanging portion includes a second connection part and a second hook part; the second connection part is connected to the second end of the connection main body; a bottom of the second hook part is connected to a bottom of the second connection part; a second hanging space is formed between the second hook part and the second connection part; the second hanging opening is formed between a top of the second connection part and a top of the second hook part; the first stop parts are first stop convex blocks; the first stop convex blocks protrudes out of the first connection part towards the first hanging space; the second stop parts are second stop convex blocks; the second stop convex blocks protrudes out of the second connection part towards the second hanging space; or, the first stop parts are first stop convex blocks, and the first stop convex blocks protrude out of the first hook part towards the first hanging space; the second stop parts are second stop convex blocks, and the second stop convex blocks protrudes out of the second hook part towards the second hanging space.

As the improvement of the present disclosure, at least two first stop parts are arranged in sequence from top to bottom from the top of the first connection part to the bottom of the first connection part; and at least two second stop parts are arranged in sequence from top to bottom from the top of the second connection part to the bottom of the second connection part.

The present disclosure also provides a tray for an automobile includes a supporting main body, a first container, and a second container; the supporting main body is configured to be detachably connected to a central console of the automobile; the first container is detachably connected to one end of the supporting main body; and the second container is detachably connected to the other end of the supporting main body.

As the improvement of the present disclosure, the first container and/or the second container is provided with a first hanging portion, and the first hanging portion is configured to hang a storage bag.

As the improvement of the present disclosure, the first container and/or the second container is also provided with a second hanging portion, and the second hanging portion is configured to hang a storage bag.

As the improvement of the present disclosure, the supporting main body is provided with a first insertion slot. The first container is provided with a first insertion block. The first insertion block is detachably inserted into the first insertion slot.

As the improvement of the present disclosure, the first container is also provided with a first stop edge, and the first insertion slot is provided with a second stop edge. When the first insertion block is detachably inserted into the first insertion slot, the first stop edge presses against the second stop edge to stop the first insertion block in the first insertion slot.

As the improvement of the present disclosure, the supporting main body is further provided with a second insertion slot, the second container is provided with a second insertion block, and the second insertion block is detachably inserted into the second insertion slot.

As the improvement of the present disclosure, the second container is also provided with a third stop edge, and the second insertion slot is provided with a fourth stop edge. When the second insertion block is detachably inserted into the second insertion slot, the third stop edge presses against the fourth stop edge to stop the second insertion block in the second insertion slot.

As the improvement of the present disclosure, the supporting main body is also provided with a third insertion slot, and the second container is also provided with a third insertion block. The third insertion block is detachably inserted into the third insertion slot.

As the improvement of the present disclosure, the supporting main body has a first accommodating cavity. The first accommodating cavity is internally provided with a first partition plate. The first partition plate separates the first accommodating cavity into a first accommodating cavity unit and a second accommodating cavity unit. The first container has a second accommodating cavity. The second accommodating cavity is internally provided with a second partition plate. The second partition plate separates the second accommodating cavity into a third accommodating cavity unit and a fourth accommodating cavity unit. The second container has a third accommodating cavity. The third accommodating cavity is internally provided with a third partition plate. The third partition plate separates the third accommodating cavity into a fifth accommodating cavity unit and a sixth accommodating cavity unit.

The present disclosure also provides a tray for an automobile includes a supporting main body, a first container, and a second container. The supporting main body is configured to be detachably connected to a central console of the automobile. The first container is connected to one end of the supporting main body, and the second container is connected to the other end of the supporting main body.

Beneficial effects of the present disclosure are as follows:The present disclosure provides a hook for an automobile. The hook for an automobile includes a connection main body, a first hanging portion and a second hanging portion. The connection main body has a first end and a second end opposite the first end. The connection main body is configured to be connected to a central console of the automobile. The first hanging portion is connected to the first end of the connection main body, and the first hanging portion is configured to hang a storage bag. The second hanging portion is connected to the second end of the connection main body, and the second hanging portion is configured to hang a storage bag. The connection main body of the hook for the automobile can be connected to a side surface, facing a passenger, of the central console of the automobile. The first hanging portion and the second hanging portion are arranged at two ends of the connection main body and parallel to the connection main body, so as to facilitate a user to hang a storage bag for storing garbage on the first hanging portion or the second hanging portion. Moreover, due to a small space occupied by the hook, the hook will not block forward and backward movements of front seats and will not affect the comfort of the passenger. Further, when the user has finished using the storage bag, the user can directly take down the storage bag from the first hanging portion or the second hanging portion of the hook for handling, which not only facilitates the user to replace the storage bag, but also has no garbage residue.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an entire structure of Embodiment I of the present disclosure;

FIG. 2 is a schematic diagram of an entire structure of connection between a connection main body and a central console of an automobile in Embodiment I according to the present disclosure;

FIG. 3 is an enlarged view of the part B in FIG. 1;

FIG. 4 is a schematic diagram of another entire structure of Embodiment I of the present disclosure;

FIG. 5 is an enlarged view of the part Ain FIG. 4;

FIG. 6 is a schematic diagram of a further entire structure of Embodiment I of the present disclosure;

FIG. 7 is an enlarged view of the part E in FIG. 6;

FIG. 8 is an enlarged view of the part F in FIG. 6;

FIG. 9 is a schematic diagram of an entire structure of Embodiment II of the present disclosure;

FIG. 10 is a schematic diagram of an entire structure of connection between a supporting main body and a central console of an automobile in Embodiment II according to the present disclosure;

FIG. 11 is an exploded view of Embodiment II of the present disclosure;

FIG. 12 is another exploded view of Embodiment II of the present disclosure;

FIG. 13 is a sectional view cut away along a first insertion block, a first insertion slot, a second insertion block, a second insertion slot, a third insertion block, and a third insertion slot of Embodiment II of the present disclosure;

FIG. 14 is an enlarged view of the part A in FIG. 13;

FIG. 15 is an enlarged view of the part B in FIG. 13;

FIG. 16 is a sectional view cut away along a first stop edge, a second stop edge, a third stop edge, and a fourth edge of Embodiment II of the present disclosure;

FIG. 17 is an enlarged view of the part C in FIG. 16; and

FIG. 18 is an enlarged view of the part D in FIG. 16.

### DETAILED DESCRIPTION OF THE EMBODIMENTS

### Embodiment I

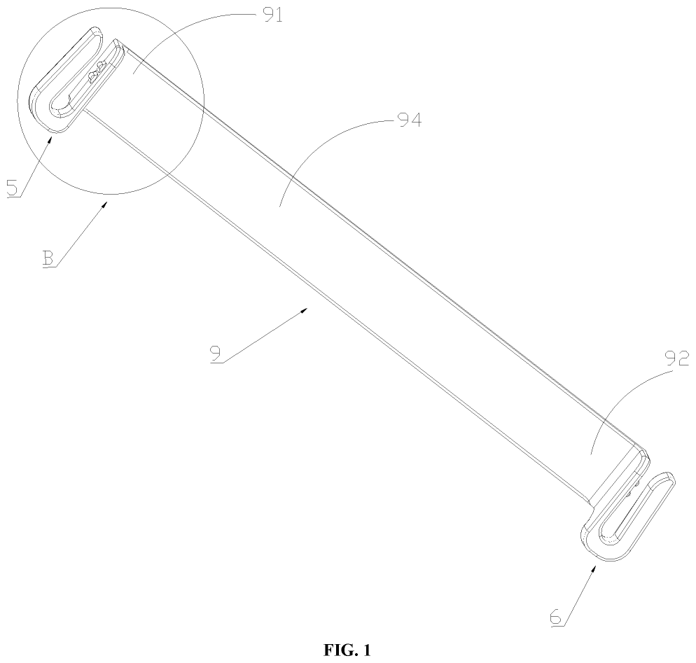

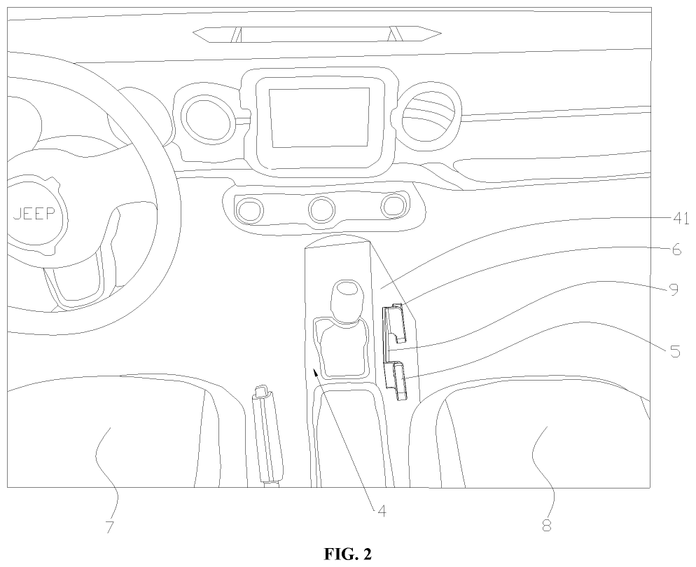

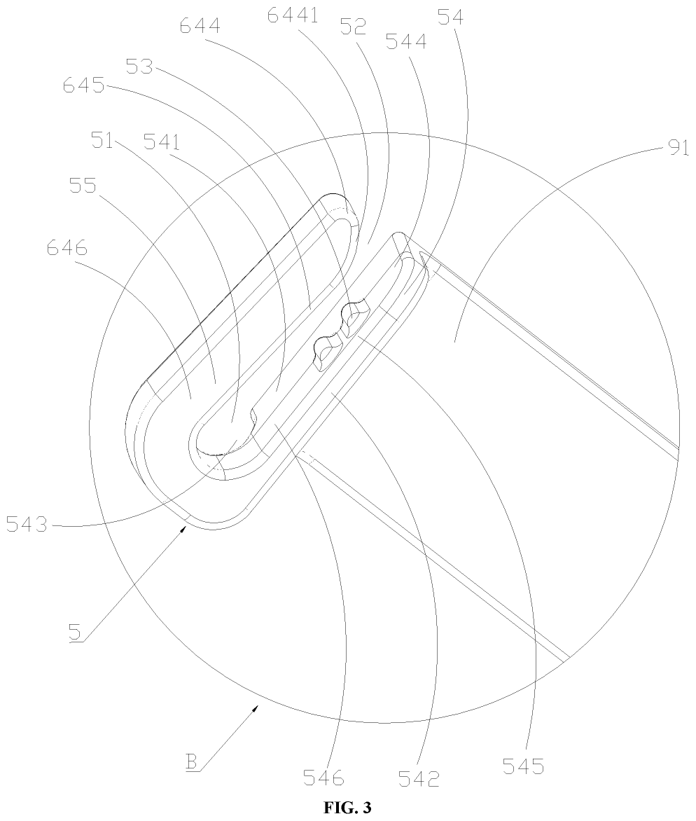

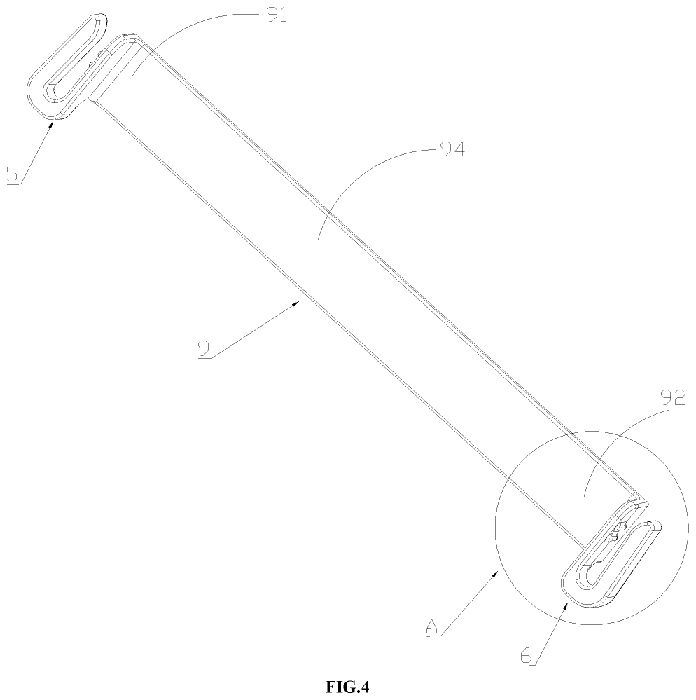

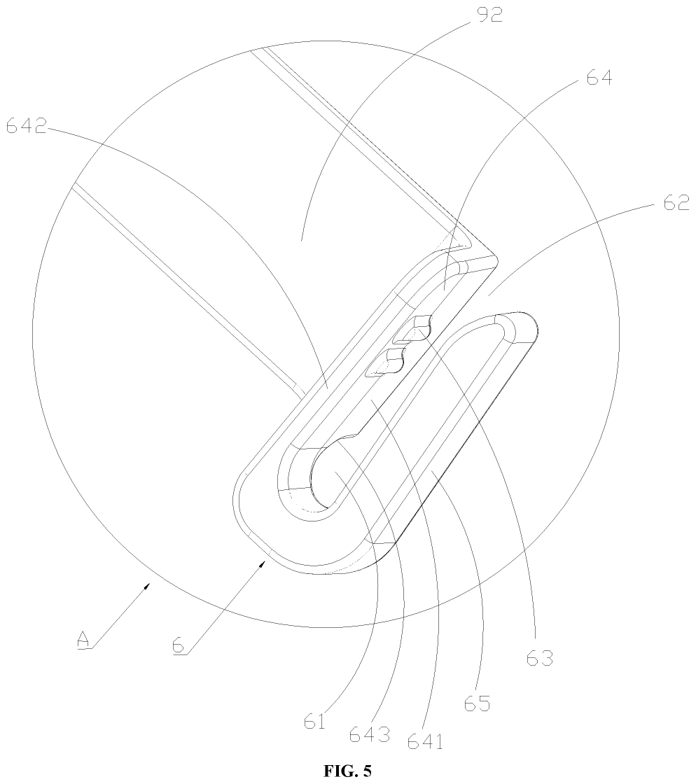

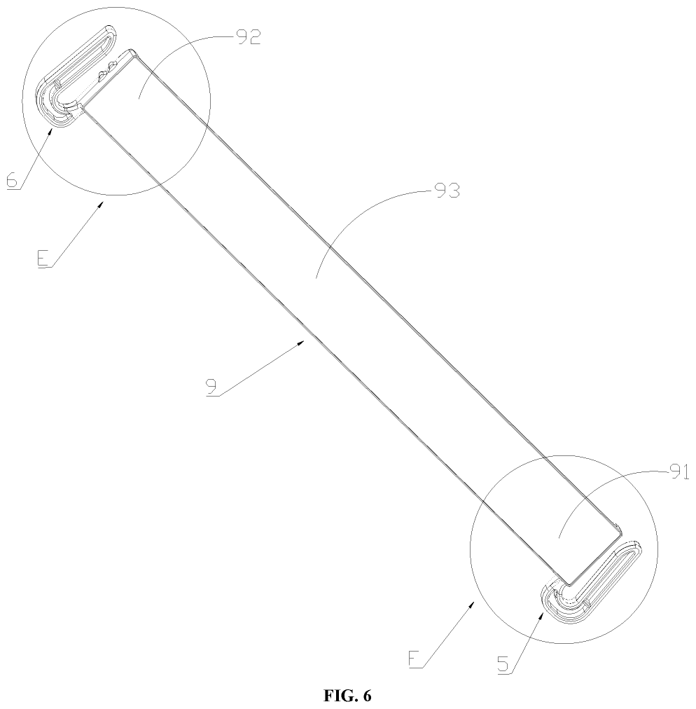

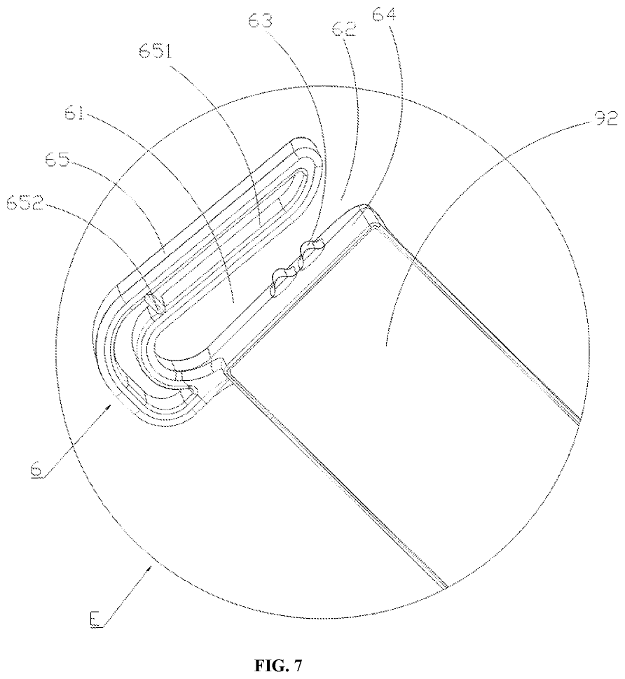

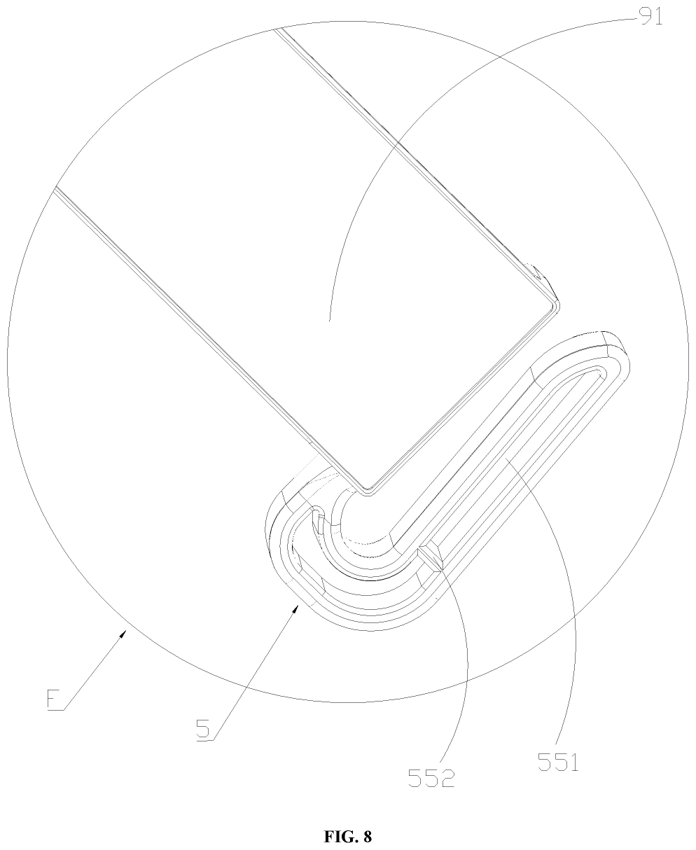

Referring to FIG. 1 to FIG. 8, a hook for an automobile includes:
a connection main body 9, wherein the connection main body 9 has a first end 91 and a second end 92 opposite the first end 91, and the connection main body 9 is configured to be connected to the automobile;
a first hanging portion 5, wherein the first hanging portion 5 is connected to the first end 91 of the connection main body 9, and the first hanging portion 5 is configured to hang a storage bag; and
a second hanging portion 6, wherein the second hanging portion 6 is connected to the second end 92 of the connection main body 9, and the second hanging portion 6 is configured to hang a storage bag.

The connection main body 9 is configured to be connected to a central console 4 of the automobile.

Through the above structure, the connection main body 9 of the hook for the automobile can be connected to a side surface 41, facing a passenger, of the central console 4 of the automobile. The first hanging portion 5 and the second hanging portion 6 are arranged at two ends of the connection main body 9 and parallel to the connection main body 9, so as to facilitate a user to hang a storage bag for storing garbage on the first hanging portion 5 or the second hanging portion 6. Moreover, due to a small space occupied by the hook, the hook will not block forward and backward movements of front seats and will not affect the comfort of the passenger. Further, when the user has finished using the storage bag, the user can directly take down the storage bag from the first hanging portion 5 or the second hanging portion 6 of the hook for handling, which not only facilitates the user to replace the storage bag, but also has no garbage residue.

In this embodiment, a protruding direction of a first hook part 55 of the first hanging portion 5 is opposite to a protruding direction of a second hook part 65 of the second hanging portion 6, and both the protruding directions are along an extending direction of the connection main body.

In this embodiment, the connection main body includes a supporting main body, a first container 2, and a second container 3; the first container 2 is connected to two ends of the supporting main body; the supporting main body 1 is detachably connected to a central console 4 of the automobile; the first container 2 is detachably connected to one end of the supporting main body 1; and the second container 3 is detachably connected to the other end of the supporting main body 1.

In this embodiment, the first hanging portion 5 has a first hanging space 51 and a first hanging opening 52; the first hanging space 51 is formed by surrounding a side wall of the first hanging portion 5; the first hanging opening 52 is communicated to the first hanging space 51, so that a hanging lug of a storage bag is hung in the first hanging space 51 through the first hanging opening 52; the first hanging portion 5 also has several first stop parts 53; and the first stop parts 53 are configured to stop the hanging lug of the storage bag in the first hanging space 51. The second hanging portion 6 has a second hanging space 61 and a second hanging opening 62; the second hanging space 61 is formed by surrounding a side wall of the second hanging portion 6; the second hanging opening 62 is communicated to the second hanging space 61, so that the hanging lug of the storage bag is hung in the second hanging space 61 through the second hanging opening 62; the second hanging portion 6 also has several second stop parts 63; and the second stop parts 63 are configured to stop the hanging lug of the storage bag in the second hanging space 61. Through the above structure, the first stop parts 53 and the second stop parts 63 can effectively prevent the hanging lug of the storage bag from rebounding and falling out of the first hanging space 51 and the second hanging space 61.

In this embodiment, the first hanging portion 5 includes a first connection part 54 and a first hook part 55, and the first connection part 54 is connected to the first end 91 of the connection main body 9; a bottom of the first hook part 55 is connected to a bottom of the first connection part 54; the first hanging space 51 is formed between the first hook part 55 and the first connection part 54; and the first hanging opening 52 is formed between a top of the first connection part 54 and a top of the first hook part 55. The second hanging portion 6 includes a second connection part 64 and a second hook part 65, and the second connection part 64 is connected to the second end 92 of the connection main body 9; a bottom of the second hook part 65 is connected to a bottom of the second connection part 64; the second hanging space 61 is formed between the second hook part 65 and the second connection part 64; and the second hanging opening 62 is formed between a top of the second connection part 64 and a top of the second hook part 65. Specifically, the first connection part 54 is arranged in an acute angle or a right angle or an obtuse angle with the connection main body 9, and the second connection part 64 is arranged in an acute angle or a right angle or an obtuse angle with the connection main body 9. Through the above structure, the arrangement of both the first hanging portion 5 and the second hanging portion 6 is effectively achieved. Moreover, the first connection part 54 and the second connection part 64 have inclination angles from the connection main body 9, so that the first hook part 55 and the second hook part 65 can extend towards a passenger. The design is reasonable, the connection is stable, and it is convenient for a user to hang the storage bag on the first hook part 55 and the second hook part 65.

In this embodiment, the first hook part 55 is provided with a first weight reduction groove 551; the first weight reduction groove 551 is internally provided with a first reinforcing rib 552; the second hook part 65 is provided with a second weight reduction groove 651; and the second weight reduction groove 651 is internally provided with a second reinforcing rib 652. Through the above structure, the design of the weight reduction grooves can reduce the gravity of the hook and also save production materials, which further reduces the production cost. Furthermore, the first reinforcing rib 552 and the second reinforcing rib 652 arranged in the first weight reduction groove 551 and the second weight reduction groove 651 can effectively improve the strength of the first hook part 55 and the strength of the second hook part 65.

In this embodiment, the first connection part 54 has a first connection side 541 and a second connection side 542; the first connection side 541 is connected to the first end 91; the second connection side 542 is connected to the first hook part 55; a height of the second connection side 542 is greater than a height of the first connection side 541; the second connection part 64 has a third connection side 641 and a fourth connection side 642; the third connection side 641 is connected to the second end 92; the fourth connection side 642 is connected to the second hook part 65; and a height of the fourth connection side 642 is greater than a height of the third connection side 641. A top of the second connection side 542 is on a same horizontal line as a top of the first connection side 541; a bottom of the second connection side 542 is located below a bottom of the first connection side 541; a first avoidance gap 543 is formed between the bottom of the second connection side 542 and the bottom of the first connection side 541; a top of the fourth connection side 642 is on a same horizontal line as a top of the third connection side 641; a bottom of the fourth connection side 642 is located below a bottom of the third connection side 641; and a second avoidance gap 643 is formed between the bottom of the fourth connection side 642 and the bottom of the third connection side 641. Through the above structure, the first avoidance gap 543 and the second avoidance gap 643 can avoid an interference part on the side surface 41, facing the passenger, of the central console 4 of the automobile, so that the connection main body 9 is in closer fit with the side surface 41, facing the passenger, of the central console 4 of the automobile.

In this embodiment, the first hanging portion 5 is integrally formed with the connection main body 9, and the second hanging portion 6 is integrally formed with the connection main body 9. The first connection part 54 is integrally formed with the first hook part 55, and the second connection part 64 is integrally formed with the second hook part 65. Through the above structure, the integrally formed first hanging portion 5, second hanging portion 6, first connection part 54, the first hook part 55, the second connection part 64, and the second hook part 65 are not only convenient for production and but also have better strength. In some embodiments, the first hanging portion 5 can also be detachably connected to the first end 91 of the connection main body 9, and the second hanging portion 6 can also be detachably connected to the second end 92 of the connection main body 9.

In this embodiment, both the first connection part 54 and the second connection part 64 have a first upper side part 544, a first middle part 545, and a first lower side part 546; both the first hook part 55 and the second hook part 65 have a second upper side part 644, a second middle part 645, and a second lower side part 646; a first spacing is reserved between the first upper side part 544 and the second upper side part 644; a second spacing is reserved between the first middle part 545 and the second middle part 645; a third spacing is reserved between the first lower side part 546 and the second lower side part 646; and the first spacing and the third spacing are both greater than the second spacing. The second upper side part 644 is provided with a first guide slope 6441. Through the above structure, the hanging lug of the storage bag can slide into the first hanging space 51 and the second hanging space 61 through the greater first spacing and the first guide slope 6441. After the sliding, the middle part with a smaller spacing can effectively prevent the storage bag from rebounding and falling off. Further, the first stop parts 53 are arranged in the first middle part 545, and the second stop parts 63 are arranged in the second middle part 645.

In this embodiment, the connection main body 9 has an inner surface 93 and an outer surface 94; the first hanging portion 5 and the second hanging portion 6 are connected to the outer surface 94 of the connection main body 9; and the inner surface 93 is configured to be connected to a side surface 41 of the central console 4 of the automobile. The inner surface 93 is configured to be detachably connected to the side surface 41 of the central console 4 of the automobile. Specifically, the inner surface 93 is detachably connected to the side surface 41 of the central console 4 of the automobile in an adhesive manner. Through the above structure, it is convenient for a user to hang the storage bag on the first hanging portion 5 and the second hanging portion 6, and the inner surface 93 can be in close fit with the side surface 41, facing the passenger, of the central console 4 of the automobile. Furthermore, the inner surface 93 is detachably connected to the side surface 41 of the central console 4 of the automobile in the adhesive manner, so that it is convenient for a user to mount and remove the hook.

Further, the first stop parts 53 are convexly arranged in the first hanging space 51; and the second stop parts 63 are convexly arranged in the second hanging space 61. A quantity of the several first stop parts 53 is at least two; and a quantity of the several second stop parts 63 is at least two. Specifically, the first hanging portion 5 includes a first connection part 54 and a first hook part 55; the first connection part 54 is connected to the first end 91 of the connection main body 9; a bottom of the first hook part 55 is connected to a bottom of the first connection part 54; a first hanging space 51 is formed between the first hook part 55 and the first connection part 54; the first hanging opening 52 is formed between a top of the first connection part 54 and a top of the first hook part 55; the second hanging portion 6 includes a second connection part 64 and a second hook part 65; the second connection part 64 is connected to the second end 92 of the connection main body 9; a bottom of the second hook part 65 is connected to a bottom of the second connection part 64; a second hanging space 61 is formed between the second hook part 65 and the second connection part 64; the second hanging opening 62 is formed between a top of the second connection part 64 and a top of the second hook part 65; the first stop parts 53 are first stop convex blocks; the first stop convex blocks protrudes out of the first connection part 54 towards the first hanging space 51; the second stop parts 63 are second stop convex blocks; the second stop convex blocks protrudes out of the second connection part 64 towards the second hanging space 61; or, the first stop parts 53 are first stop convex blocks, and the first stop convex blocks protrude out of the first hook part 55 towards the first hanging space 51; and the second stop parts 63 are second stop convex blocks, and the second stop convex blocks protrudes out of the second hook part 65 towards the second hanging space 61. Further, at least two first stop parts 53 are arranged in sequence from top to bottom from the top of the first connection part 54 to the bottom of the first connection part 54; and at least two second stop parts 63 are arranged in sequence from top to bottom from the top of the second connection part 64 to the bottom of the second connection part 64. Through the above structure, the at least two second stop parts 63 are arranged in sequence from top to bottom from the top of the second connection part 64 to the bottom of the first connection part 54, so that dual-layer protection for preventing the storage bag from rebounding and falling off can be formed.

### Embodiment II

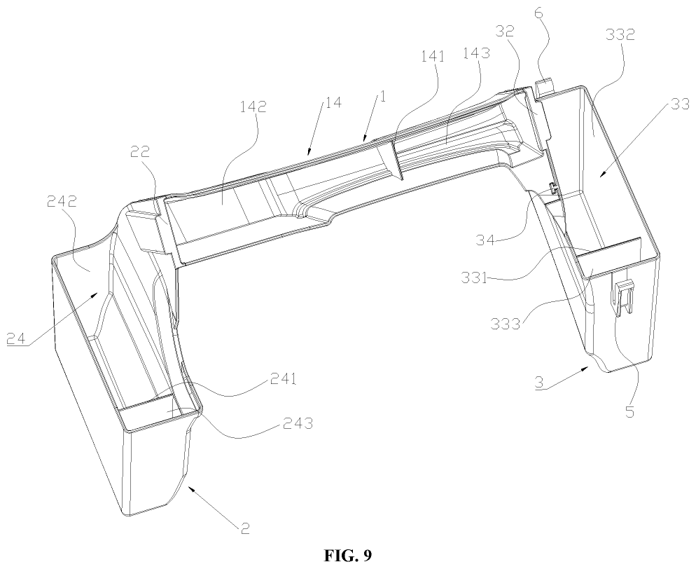

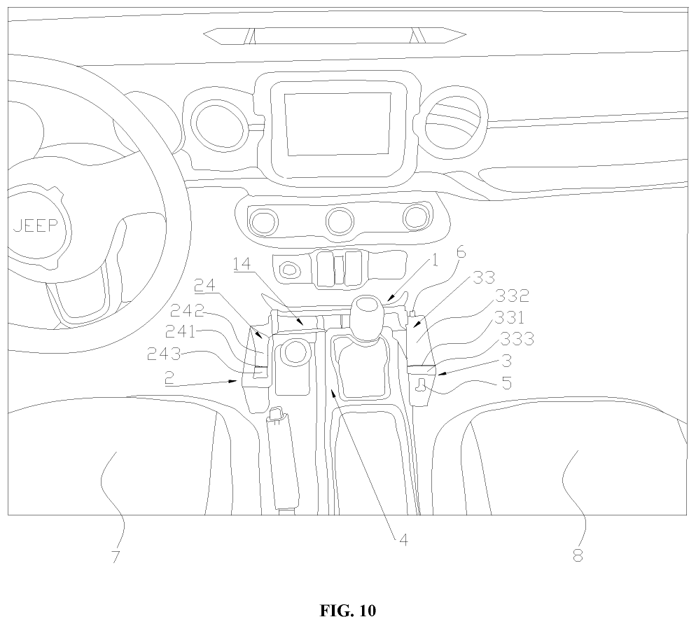

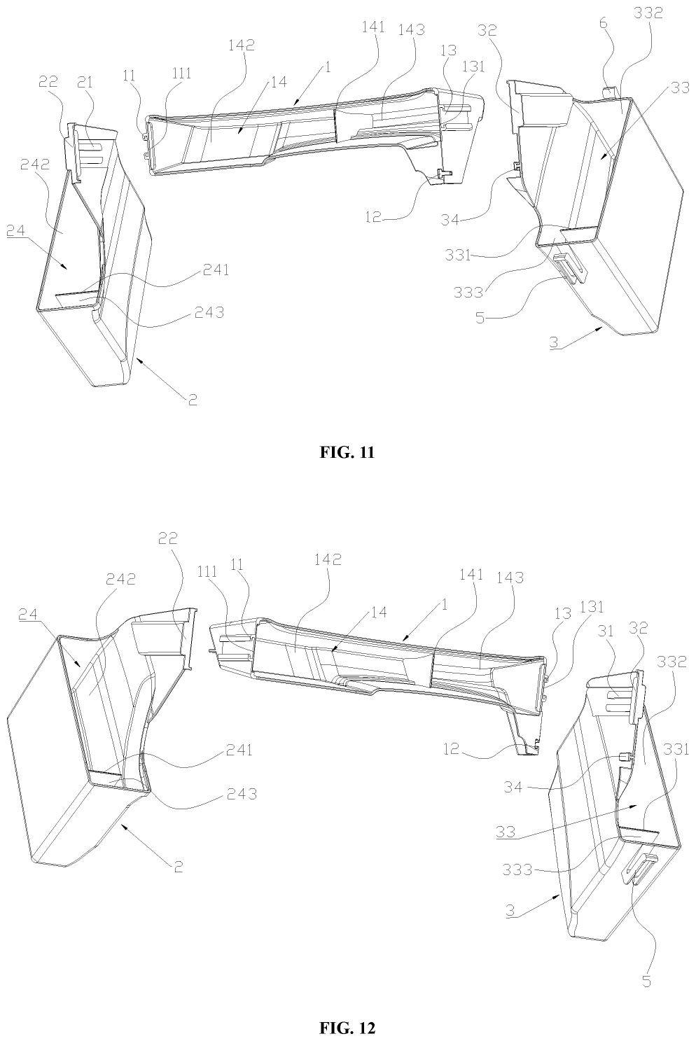

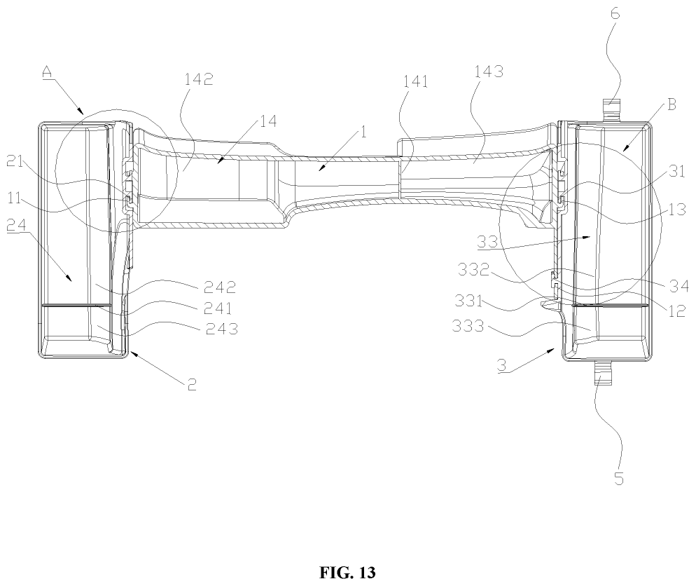

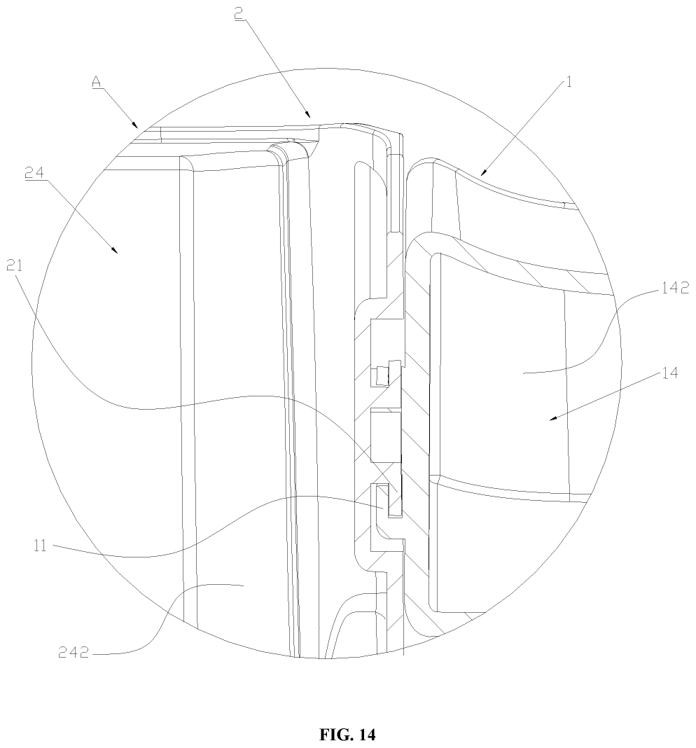

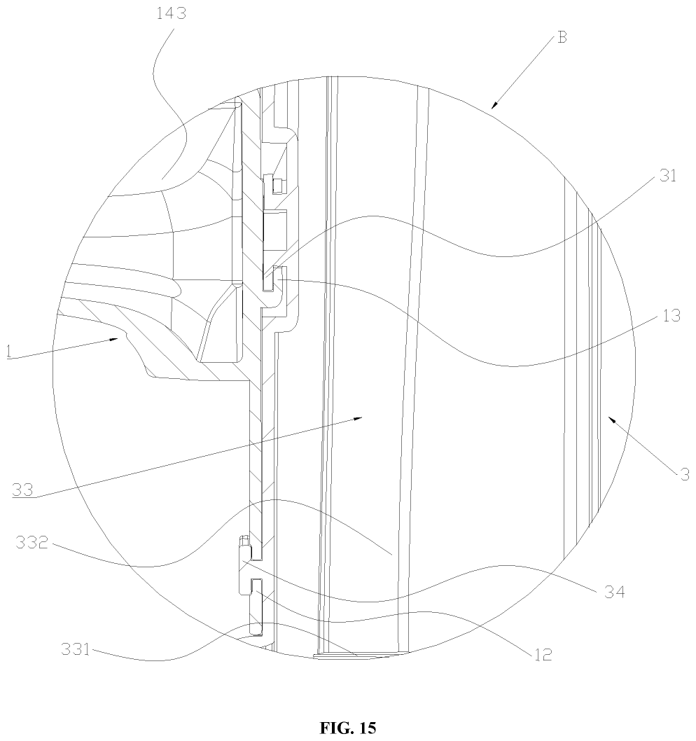

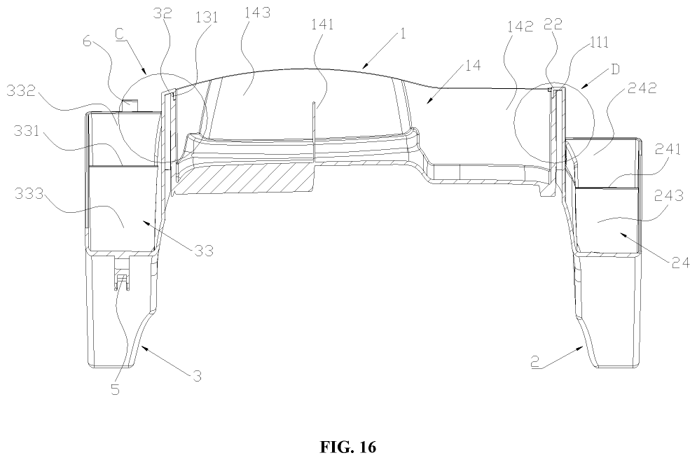

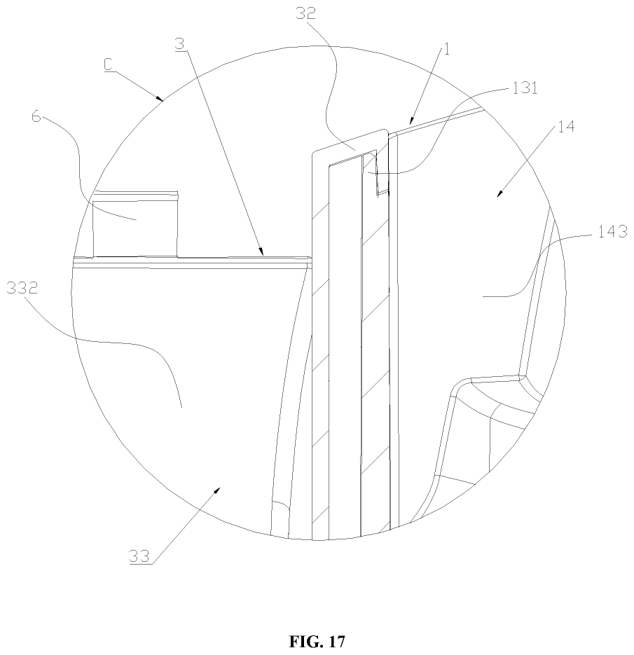

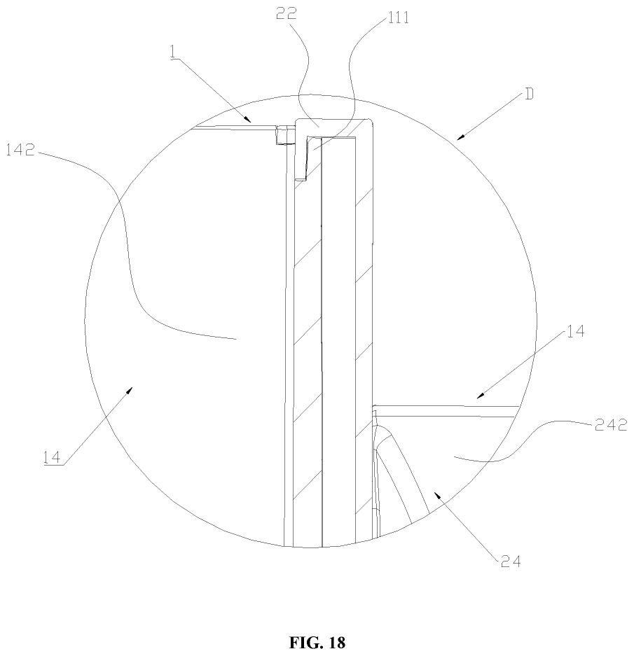

Referring to FIG. 9 to FIG. 18, a tray for an automobile includes a supporting main body 1, a first container 2, and a second container 3; the supporting main body 1 is configured to be detachably connected to a central console 4 of the automobile; the first container 2 is detachably connected to one end of the supporting main body 1; and the second container 3 is detachably connected to the other end of the supporting main body 1.

Through the above structure, the tray includes the supporting main body, the first container, and the second container. The supporting main body is configured to be detachably connected to the central console of the automobile, the first container is detachably connected to one end of the supporting main body, and the second container is detachably connected to the other end of the supporting main body, so that when a user needs to place an object on the tray on the central console of the automobile, the supporting main body of the tray can be detachably connected to the central console of the automobile to achieve mounting of the tray. Moreover, when the user does not need to use the tray, the supporting main body of the tray can be removed from the central console to remove the tray from the central console, which prevents the tray from continuing to occupy the internal space of the vehicle. Further, as the first container is detachably connected to one end of the supporting main body, and the second container is detachably connected to the other end of the supporting main body, when the user needs to adjust a seat, the user can select to remove the entire tray or remove the first container and/or second container from the supporting main body to effectively avoid the tray from interfering with the seat. This facilitates the user to adjust the seat to an appropriate position and greatly improves the user experience. The central console is located between a driver seat 7 and a front passenger seat 8. The first container is arranged close to the driver seat 7, and the second container is arranged close to the front passenger seat 8, so that a driver in the driver seat 7 can place an object on the first container of the tray, and a passenger in the front passenger seat 8 can place an object on the second container of the tray. Specifically, to adjust a seat position of the driver seat 7, the entire tray can be removed from the central console, or the first container is removed from the supporting main body to prevent interference between the first container of the tray and the seat, making it easier for the driver in the driver seat 7 to adjust the seat position of the driver seat. Further, to adjust a seat position of the front passenger seat 8, the entire tray can be removed from the central console, or the second container is removed from the supporting main body to prevent interference between the second container of the tray and the seat, making it easier for the passenger in the front passenger seat 8 to adjust the seat position of the front passenger seat 8. Further, as the first container is detachably connected to one end of the supporting main body, and the second container is detachably connected to the other end of the supporting main body, the user can remove the first container and the second container from the supporting main body, making it easier for the user to package, carry, and transport the tray and for a seller to deliver the tray to the user. This greatly saves the transportation cost of the tray.

In this embodiment, the supporting main body can be placed on the central console through a simple support to achieve the detachable connection between the supporting main body and the central console. The supporting main body can also be detachably connected to the central console through a double-sided adhesive. The tray for the automobile can be made of a plastic material, a rubber material, a metal material, or a carbon fiber material. The tray made of the plastic material is used in this embodiment, and surface treatment such as spraying is performed on the tray made of the plastic material, so that the tray looks more beautiful. Specifically, the supporting main body can also be set to be retractable to match central consoles in different sizes, so that the tray is applicable to the central consoles of various vehicle models.

In this embodiment, the first container 2 and/or the second container 3 is provided with a first hanging portion 5, and the first hanging portion 5 is configured to hang a storage bag. The first container 2 and/or the second container 3 is also provided with a second hanging portion 6, and the second hanging portion 6 is configured to hang a storage bag. Specifically, the storage bag can be a garbage storage bag or other types of object storage bags. Further, the first hanging portion can be arranged on one side of the first container, and the second hanging portion can be arranged on the other side of the first container. Or, the first hanging portion is arranged on one side of the second container, and the second hanging portion is arranged on the other side of the second container. Or, the first hanging portion is arranged on the first container, and the second hanging portion is arranged on the second container. Through the above structure, the driver in the driver seat and/or the passenger in the front passenger seat can hang the storage bag on the first hanging portion and/or the second hanging portion, so that it is convenient for the driver and the passenger to put garbage and other objects into the storage bag. This is not only reasonable in design, simple in structure, and stable in connection, but also is convenient for a user to replace the storage bag.

In this embodiment, the supporting main body 1 is provided with a first insertion slot 11. The first container 2 is provided with a first insertion block 21. The first insertion block 21 is detachably inserted into the first insertion slot 11. The first container 2 is also provided with a first stop edge 22, and the first insertion slot 11 is provided with a second stop edge 111. When the first insertion block 21 is detachably inserted into the first insertion slot 11, the first stop edge 22 presses against the second stop edge 111 to stop the first insertion block 21 in the first insertion slot 11. Through the above structure, the design is reasonable, the structure is simple, and the connection is stable, effectively achieving the detachable connection between the first container and the supporting main body. Moreover, when the first insertion block is detachably inserted in the first insertion slot, the first stop edge presses against the second stop edge to stop the first insertion block in the first insertion slot, which effectively prevents the first insertion block from being separated from the first insertion slot and prevents the first container from being separated from the supporting main body. Further, when a user needs to remove the first container from the supporting main body, the user only needs to remove the first insertion block from the first insertion slot in a direction away from the second stop edge. This can easily remove the first container from the supporting main body.

In this embodiment, the supporting main body 1 is further provided with a second insertion slot 13, the second container 3 is provided with a second insertion block 31, and the second insertion block 31 is detachably inserted into the second insertion slot 13. The second container 3 is also provided with a third stop edge 32, and the second insertion slot 13 is provided with a fourth stop edge 131. When the second insertion block 31 is detachably inserted into the second insertion slot 13, the third stop edge 32 presses against the fourth stop edge 131 to stop the second insertion block 31 in the second insertion slot 13. Specifically, the supporting main body 1 is also provided with a third insertion slot 12, and the second container 3 is also provided with a third insertion block 34. The third insertion block 34 is detachably inserted into the third insertion slot 12. Through the above structure, the design is reasonable, the structure is simple, and the connection is stable, effectively achieving the detachable connection between the second container and the supporting main body. Moreover, when the second insertion block is detachably inserted in the second insertion slot, the third stop edge presses against the fourth stop edge to stop the second insertion block in the second insertion slot, which effectively prevents the second insertion block from being separated from the second insertion slot and prevents the second container from being separated from the supporting main body. Further, the third insertion block is detachably inserted into the third insertion slot, so that the connection between the first container and the supporting main body is more stable. Much further, when a user needs to remove the second container from the supporting main body, the user only needs to remove the second insertion block from the second insertion slot in a direction away from the fourth stop edge and remove the third insertion block from the third insertion slot, so that the second container can be easily removed from the supporting main body.

In this embodiment, the supporting main body 1 has a first accommodating cavity 14. The first accommodating cavity 14 is internally provided with a first partition plate 141. The first partition plate 141 separates the first accommodating cavity 14 into a first accommodating cavity unit 142 and a second accommodating cavity unit 143. The first container 2 has a second accommodating cavity 24. The second accommodating cavity 24 is internally provided with a second partition plate 241. The second partition plate 241 separates the second accommodating cavity 24 into a third accommodating cavity unit 242 and a fourth accommodating cavity unit 243. The second container 3 has a third accommodating cavity 33. The third accommodating cavity 33 is internally provided with a third partition plate 331. The third partition plate 331 separates the third accommodating cavity 33 into a fifth accommodating cavity unit 332 and a sixth accommodating cavity unit 333. Through the above structure, a user can place different types of objects into the first accommodating cavity unit, the second accommodating cavity unit, the third accommodating cavity unit, the fourth accommodating cavity unit, the fifth accommodating cavity unit, and the sixth accommodating cavity unit, respectively. For example, the user can place sunglasses into the first accommodating cavity unit, place peripheral electronic devices such as a power bank into the second accommodating cavity unit, place a mobile phone into the third or fifth accommodating cavity unit, and place an electronic cigarette into the fourth or sixth accommodating cavity unit.

Referring to FIG. 1 to FIG. 10, a tray for an automobile includes a supporting main body 1, a first container 2, and a second container 3. The supporting main body 1 is configured to be detachably connected to a central console 4 of the automobile. The first container 2 is connected to one end of the supporting main body 1, and the second container 3 is connected to the other end of the supporting main body 1.

Through the above structure, the tray includes the supporting main body, the first container, and the second container. The supporting main body is configured to be detachably connected to the central console of the automobile, the first container is connected to one end of the supporting main body, and the second container is connected to the other end of the supporting main body, so that when a user needs to place an object on the tray on the central console of the automobile, the supporting main body of the tray can be detachably connected to the central console of the automobile to achieve mounting of the tray. Moreover, when the user does not need to use the tray, the supporting main body of the tray can be removed from the central console to remove the tray from the central console, which prevents the tray from continuing to occupy the internal space of the vehicle. When the user needs to adjust a seat, the user can select to remove the tray from the central console to effectively avoid the tray from interfering with the seat. This facilitates the user to adjust the seat to an appropriate position and greatly improves the user experience. The central console is located between a driver seat and a front passenger seat. The first container is arranged close to the driver seat, and the second container is arranged close to the front passenger seat, so that a driver in the driver seat can place an object on the first container of the tray, and a passenger in the front passenger seat can place an object on the second container of the tray.

As described above, one or more embodiments are provided in conjunction with the detailed description, The specific implementation of the present disclosure is not confirmed to be limited to that the description is similar to or similar to the method, the structure and the like of the present disclosure, or a plurality of technical deductions or substitutions are made on the premise of the conception of the present disclosure to be regarded as the protection of the present disclosure.

What is claimed is:

1. A hook for an automobile, comprising:
a connection main body, wherein the connection main body has a first end and a second end opposite the first end, and the connection main body is configured to be connected to the automobile;
a first hanging portion, wherein the first hanging portion is connected to the first end of the connection main body, and the first hanging portion is configured to hang a storage bag; and
a second hanging portion, wherein the second hanging portion is connected to the second end of the connection main body, and the second hanging portion is configured to hang a storage bag.

2. The hook for the automobile according to claim 1, wherein a protruding direction of a first hook part of the first hanging portion is opposite to a protruding direction of a second hook part of the second hanging portion, and both the protruding directions are along an extending direction of the connection main body.

3. The hook for the automobile according to claim 1, wherein the connection main body comprises a supporting main body, a first container, and a second container; the first container is connected to two ends of the supporting main body; the supporting main body is detachably connected to a central console of the automobile; the first container is detachably connected to one end of the supporting main body; and the second container is detachably connected to the other end of the supporting main body.

4. The hook for the automobile according to claim 1, wherein the first hanging portion has a first hanging space and a first hanging opening; the first hanging space is formed by surrounding a side wall of the first hanging portion; the first hanging opening is communicated to the first hanging space, so that a hanging lug of a storage bag is hung in the first hanging space through the first hanging opening; the first hanging portion also has several first stop parts; and the first stop parts are configured to stop the hanging lug of the storage bag in the first hanging space.

5. The hook for the automobile according to claim 4, wherein the second hanging portion has a second hanging space and a second hanging opening; the second hanging space is formed by surrounding a side wall of the second hanging portion; the second hanging opening is communicated to the second hanging space, so that the hanging lug of the storage bag is hung in the second hanging space through the second hanging opening; the second hanging portion also has several second stop parts; and the second stop parts are configured to stop the hanging lug of the storage bag in the second hanging space.

6. The hook for the automobile according to claim 4, wherein the first hanging portion comprises a first connection part and a first hook part, and the first connection part is connected to the first end of the connection main body; a bottom of the first hook part is connected to a bottom of the first connection part; the first hanging space is formed between the first hook part and the first connection part; and the first hanging opening is formed between a top of the first connection part and a top of the first hook part.

7. The hook for the automobile according to claim 6, wherein the second hanging portion comprises a second connection part and a second hook part, and the second connection part is connected to the second end of the connection main body; a bottom of the second hook part is connected to a bottom of the second connection part; the second hanging space is formed between the second hook part and the second connection part; and the second hanging opening is formed between a top of the second connection part and a top of the second hook part.

8. The hook for the automobile according to claim 7, wherein the first connection part is arranged in an acute angle or a right angle or an obtuse angle with the connection main body, and the second connection part is arranged in an acute angle or a right angle or an obtuse angle with the connection main body.

9. The hook for the automobile according to claim 7, wherein the first hook part is provided with a first weight reduction groove; the first weight reduction groove is internally provided with a first reinforcing rib; the second hook part is provided with a second weight reduction groove; and the second weight reduction groove is internally provided with a second reinforcing rib.

10. The hook for the automobile according to claim 7, wherein the first connection part has a first connection side and a second connection side; the first connection side is connected to the first end; the second connection side is connected to the first hook part; a height of the second connection side is greater than a height of the first connection side; the second connection part has a third connection side and a fourth connection side; the third connection side is connected to the second end; the fourth connection side is connected to the second hook part; and a height of the fourth connection side is greater than a height of the third connection side.

11. The hook for the automobile according to claim 10, wherein a top of the second connection side is on a same horizontal line as a top of the first connection side; a bottom of the second connection side is located below a bottom of the first connection side; a first avoidance gap is formed between the bottom of the second connection side and the bottom of the first connection side; a top of the fourth connection side is on a same horizontal line as a top of the third connection side; a bottom of the fourth connection side is located below a bottom of the third connection side; and a second avoidance gap is formed between the bottom of the fourth connection side and the bottom of the third connection side.

12. The hook for the automobile according to claim 1, wherein the first hanging portion is integrally formed with the connection main body, and the second hanging portion is integrally formed with the connection main body.

13. The hook for the automobile according to claim 7, wherein the first connection part is integrally formed with the first hook part, and the second connection part is integrally formed with the second hook part.

14. The hook for the automobile according to claim 7, wherein both the first connection part and the second connection part have a first upper side part, a first middle part, and a first lower side part; both the first hook part and the second hook part have a second upper side part, a second middle part, and a second lower side part; a first spacing is reserved between the first upper side part and the second upper side part; a second spacing is reserved between the first middle part and the second middle part; a third spacing is reserved between the first lower side part and the second lower side part; and the first spacing and the third spacing are both greater than the second spacing.

15. The hook for the automobile according to claim 14, wherein the second upper side part is provided with a first guide slope.

16. The hook for the automobile according to claim 1, wherein the connection main body has an inner surface and an outer surface; the first hanging portion and the second hanging portion are connected to the outer surface of the connection main body; and the inner surface is configured to be connected to a side surface of the central console of the automobile.

17. The hook for the automobile according to claim 16, wherein the inner surface is configured to be detachably connected to the side surface of the central console of the automobile.

18. The hook for the automobile according to claim 17, wherein the inner surface is detachably connected to the side surface of the central console of the automobile in an adhesive manner.

19. The hook for the automobile according to claim 5, wherein the first stop parts are convexly arranged in the first hanging space; the second stop parts are convexly arranged in the second hanging space; a quantity of the several first stop parts is at least two; and a quantity of the several second stop parts is at least two.

20. The hook for the automobile according to claim 19, wherein the first hanging portion comprises a first connection part and a first hook part; the first connection part is connected to the first end of the connection main body; a bottom of the first hook part is connected to a bottom of the first connection part; a first hanging space is formed between the first hook part and the first connection part; the first hanging opening is formed between a top of the first connection part and a top of the first hook part; the second hanging portion comprises a second connection part and a second hook part; the second connection part is connected to the second end of the connection main body; a bottom of the second hook part is connected to a bottom of the second connection part; a second hanging space is formed between the second hook part and the second connection part; the second hanging opening is formed between a top of the second connection part and a top of the second hook part; the first stop parts are first stop convex blocks; the first stop convex blocks protrudes out of the first connection part towards the first hanging space; the second stop parts are second stop convex blocks; the second stop convex blocks protrudes out of the second connection part towards the second hanging space; or, the first stop parts are first stop convex blocks, and the first stop convex blocks protrude out of the first hook part towards the first hanging space; the second stop parts are second stop convex blocks, and the second stop convex blocks protrudes out of the second hook part towards the second hanging space; at least two first stop parts are arranged in sequence from top to bottom from the top of the first connection part to the bottom of the first connection part; and at least two second stop parts are arranged in sequence from top to bottom from the top of the second connection part to the bottom of the second connection part.
